(19) United States
(12) Patent Application Publication
(10) Pub. No.: US 2021/0370595 A1
(43) Pub. Date: Dec. 2, 2021

(54) 3D PRINTER

(71) Applicant: Mühlbauer Technology GmbH, Hamburg (DE)

(72) Inventor: Jens TRÄGER, Hetlingen (DE)

(21) Appl. No.: 17/272,711

(22) PCT Filed: Sep. 19, 2019
(86) PCT No.: PCT/EP2019/075107

§ 371 Date: Mar. 2, 2021

(30) Foreign Application Priority Data
Sep. 21, 2018 (DE) 10 2018 123 254.3

(51) Int. Cl. B29C 64/277; B33Y 30/00

(52) U.S. Cl. CPC B29C 64/277; B33Y 30/00

(57) ABSTRACT

The application relates to a 3D printer (1) comprising a flat base panel (4) and an exposure element (10) which is arranged opposite and parallel to the base panel (4), the distance between the base panel (4) and the exposure element (10) being adjustable with the aid of a drive unit (6), and the base panel (4) and/or the exposure element (10) being arranged in a reservoir (3) filled with resin (2) such that the region bordering the base panel (4) between the base panel (4) and the exposure element (10) is occupied by the resin (2) in the reservoir (3). According to the invention, the exposure element (10) is formed as a two-dimensional matrix of quantum dot light-emitting diodes (11) which are situated closely next to one another and can be activated individually.

The invention relates to a 3D printer.

In the prior art, 3D printers of various construction types and for different printing methods are known. A well-known printing method is here the stereolithographic method, in which a suitable liquid resin or monomer formulation is cured point by point by targeted exposure to light in order to produce a desired three-dimensional object layer by layer.

In conventional stereolithography, a focused laser beam is deflected for this purpose via a mirror that is pivotable about two mutually perpendicular axes in order to successively move through the resin in the points that are to be cured in a layer and thus to expose said resin to light. In particular if the aim is to cure larger areas, this method is time-consuming since the areas to be cured must be traversed point by point, in other words the areas have to be practically hatched by the laser. In the case of larger objects, it is even possible for distortions to occur in the peripheral region if the laser strikes the resin to be cured only at a flat angle.

As an alternative to this, what is known as the “digital light processing” (DLP) printing method was developed. In this method, the light from a light source is directed onto the resin to be cured via a digital micromirror unit. The micromirror unit here comprises a rectangular arrangement of tiltable micromirrors, which are individually controllable. Typical micromirror units comprise 1920×1080 individual controllable mirrors, which can be pivoted between a position in which the light that is incident thereon is deflected to a respectively specified point in the resin and a second position in which this does not happen. The number of individually curable points in a layer of the resin is specified by the number of the mirrors of the micromirror unit. The final size of the individual points in the resin can be influenced by the distance between the micromirror unit and the layer to be exposed. Larger components can be printed with a greater distance, but the resolution decreases. In the peripheral regions, distortions may also occur owing to light being incident on the resin only in a flat manner, comparable to stereo-lithography.

In both conventional stereolithography and digital light processing, the 3D printers regularly require a large amount of space because of the required beam deflection due to pivotable mirrors.

In the prior art, embodiments are furthermore known in which an LCD display illuminated from behind by a two-dimensional light source is used, rather than a micromirror unit illuminated by a light source, in order to cure resin at desired points. The LCD display, which can selectively transmit the light from the illumination located behind it at individual points, must be arranged in this case directly at the layer with the points to be cured in the otherwise liquid resin.

Corresponding LCD displays have the disadvantage that, due to the permanent, large-area illumination from behind and the absorption of light thereof at the points in a layer that are not to be cured, heating of the LCD display occurs. In particular since the dissipation of heat is limited due to the resin lying directly against the LCD display, the increased temperature can cause temporary malfunctions in the LCD display, with the result that printing fails or at least has to be interrupted. Moreover, the process of curing the resin can be adversely affected by excessively high temperatures.

The invention is therefore based on the object of producing a 3D printer which is improved compared to this prior art.

This object is achieved by a 3D printer according to the main claim. Advantageous developments are the subject matter of the dependent claims.

Accordingly, the invention relates to a 3D printer comprising a flat build-up plate and, arranged opposite and parallel to the build-up plate, an exposure element, wherein the distance is settable with the aid of a drive unit, wherein the build-up plate and/or the exposure element is arranged in a resin-filled reservoir such that the region adjoining the build-up plate between the build-up plate and the exposure element is taken up by the resin in the reservoir, and wherein the exposure element is a two-dimensional matrix made of individually controllable quantum dot light-emitting diodes lying close next to one another.

The invention has recognized that, proceeding from the prior art mentioned in the introductory part, the use of an exposure element with self-luminous exposure points is advantageous. Compared to conventional and slow stereolithography and “digital light processing,” it is possible, since no beam deflection is required, to achieve a smaller installation size of the 3D printer with a printing speed comparable to the DLP method. Compared to 3D printers with LCD displays, it is possible due to the use according to the invention of quantum dot light-emitting diodes, to reduce the generation of heat in the region of the exposure element to such a low level that neither the functionality of the exposure element nor the 3D printing as such is impaired.

The invention has furthermore recognized that the exposure of resin required in connection with 3D printing regularly requires low wavelengths, for example in the blue-violet range of visible light or in the UV range, for curing purposes. It is precisely in these wavelength ranges that organic light-emitting diodes (OLEDs), which at first glance could also be regarded as suitable for forming an exposure element, exhibit considerable aging effects that can lead to a reduction in print quality even after a 3D printer that is equipped with them has been in operation only for a short time. It is a merit of the invention to have recognized that quantum dot light-emitting diodes are particularly advantageous for the special application of 3D printing since they age significantly less quickly than OLEDs.

In addition, it was recognized as a basis for the invention that quantum dot light-emitting diodes can in principle be arranged without difficulty in the exposure element provided according to the invention and may also be produced in the range required for curing resin (cf., for example, J. Kwak et al.: High-Power Genuine Ultraviolet Light-Emitting Diodes Based On Colloidal Nanocrystal Quantum Dots—in Nano Letters, 2015, 15 (6), pages 3793-3799). It should also be pointed out that quantum dot light-emitting diodes are provided according to the invention, that is to say diodes that are self-luminous when electrically excited, which clearly distinguishes them from the arrangement of quantum dots that changes the light from a light source in a manner comparable to an LCD display.

Aside from that, the 3D printer according to the invention is substantially the same as known 3D printers. The distance between a flat build-up plate and the exposure element can be increased step by step with the aid of a drive unit, wherein the resin located between the build-up plate and the exposure element is cured layer by layer with each step, starting from the build-up plate, so that a 3D model adhering to the build-up plate is obtained step by step and layer by layer.

It is preferred if the exposure element is monochromatic. In other words, all quantum dot light-emitting diodes of the exposure element should emit radiation at the same wavelength. By relying on monochromatic exposure, which is in principle sufficient for 3D printing, only one individual quantum dot light-emitting diode is required for each exposure point of the exposure element, which in principle makes possible a higher resolution than with a polychromatic design, in which a plurality of light-emitting diodes of different emission wavelengths regularly must be combined to form one exposure point.

It is preferred if the wavelength of the radiation emitted by the exposure element is less than or equal to 450 nm, preferably less than or equal to 410 nm, for example 405 nm, more preferably less than or equal to 390 nm, for example 385 nm. Resins with curing properties that are very good for 3D printing can be produced in particular in the last-mentioned UV range.

It is preferred that the resin located in the reservoir of the 3D printer according to the invention is matched to the wavelength(s) of the exposure element, that is to say, in particular cures at the wavelength emitted by the exposure element. If the exposure element is monochromatic, the resin or its properties with respect to the curing behavior can be matched very well to the exposure element, which can increase the print quality.

It is preferred if the build-up plate is arranged in the reservoir and the exposure element rests against a transparent region of the resin reservoir from the outside. Such an arrangement ensures that neither the exposure element nor its electrical control comes into direct contact with the resin and could be damaged as a result.

It is preferred if the exposure element is composed of a plurality of exposure element tiles. Since the exposure element is composed of exposure element tiles, the exposure region of the exposure element can be expanded by adding further tiles, without the size of the exposure points changing as a result. Rather, the number of exposure points can be increased almost as desired by one or more additional tiles in order to be able to even print larger objects with good resolution. Of course, the size of the exposure element can also be selected almost as desired.

It is preferred if the exposure points of the exposure element have a size of at most 70 μm, preferably of at most 35 μm. The specified length here refers to the nominal size that is typical for the respective shape of the exposure points, i.e. the diameter for circular exposure points, an edge length for square exposure points, the diagonal length for rectangular exposure points, etc.

The invention will now be described by way of example on the basis of an advantageous exemplary embodiment, with reference to the accompanying drawing, in which:

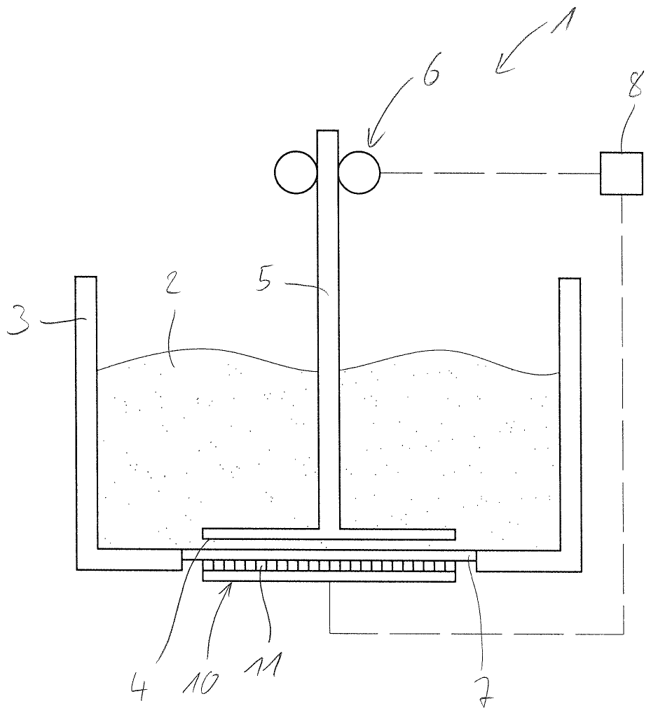

FIG. 1: shows a first exemplary embodiment of a 3D printer according to the invention.

FIG. 1 illustrates a 3D printer 1 according to the invention. The 3D printer 1 comprises a reservoir 3 filled with resin 2. Arranged in this reservoir 3 and immersed in the resin 2, is a horizontally aligned build-up plate 4, which can be displaced in the vertical direction via its suspension 5 and the drive unit 6.

A transparent window 7, against which an exposure element 10 rests from the outside, is provided at the bottom of the reservoir 3. The exposure element is thus arranged parallel and opposite to the build-up plate 4, wherein the distance between the two elements 4, 10 can be changed by the drive unit 6. Since the build-up plate 4 is located in the reservoir 3, the region adjoining the build-up plate 4 between the build-up plate 4 and the exposure element 10—to be specific the region between the build-up plate 4 and the window 7—is always filled with resin 2.

The exposure element 10 is formed as a two-dimensional matrix of closely adjacent, individually controllable quantum dot light-emitting diodes 11, all of which have a wavelength of 385 nm, meaning that the exposure element 10 is monochromatic. The size of the square quantum dot light-emitting diodes is 35 μm, wherein the dimension in this case relates to the edge length of the square.

The drive unit 6 and the exposure element 10 are controlled by the control unit 8.

For the actual 3D printing, starting from the position of the build-up plate 4 shown in FIG. 1, the quantum dot light-emitting diodes 11 of the exposure element 10 are first activated in order to cure the resin 2 at the desired exposure points. The resin 2 is matched in this case to the wavelength of the exposure element 10 and cures particularly well and reliably at its wavelength. The cured resin 2 adheres to the build-up plate 4. When the first layer has cured sufficiently, the build-up plate 4 is moved vertically upward by one step by the drive unit 6 and the resin is cured again by suitably controlling the exposure element 10. The resin 2 that has cured in this layer adheres to the points that were cured in the previous step. A complete 3D model can thus be produced layer by layer.

1. A 3D printer (1), comprising a flat build-up plate (4) and, arranged opposite and parallel to the build-up plate (4), an exposure element (10), wherein the distance between the build-up plate (4) and the exposure element (10) is settable with the aid of a drive unit (6) and wherein the build-up plate (4) and/or the exposure element (10) is arranged in a reservoir (3) filled with resin (2) in such a way that the region adjoining the build-up plate (4) between the build-up plate (4) and the exposure element (10) is taken up by the resin (2) in the reservoir (3),
characterized in that
the exposure element (10) is a two-dimensional matrix made of individually controllable quantum dot light-emitting diodes (11) lying close next to one another, wherein the quantum dot light-emitting diodes (11) are diodes that are self-luminous when electrically excited.

2. The 3D printer as claimed in claim 1,
characterized in that
the exposure element (10) is monochromatic.

3. The 3D printer as claimed in claim 1 or 2,
characterized in that
the wavelength of the radiation emitted by the exposure element (10) is less than or equal to 450 nm, preferably less than or equal to 410 nm, more preferably less than or equal to 390 nm.

4. The 3D printer as claimed in one of the claims,
characterized in that
the resin (2) contained in the reservoir (3) is selected such that it cures when irradiated with the wavelength emitted by the exposure element (10).

5. The 3D printer as claimed in one of the preceding claims,
characterized in that
the build-up plate (4) is arranged in the reservoir (3) and the exposure element (10) rests against a transparent region (7) of the reservoir (3) from the outside.

6. The 3D printer as claimed in one of the preceding claims,
characterized in that
the exposure element (10) is composed of a plurality of exposure element tiles.

7. The 3D printer as claimed in one of the preceding claims,
characterized in that
the exposure points of the exposure element (10) have a size of at most 70 μm, preferably at most 35 μm.
